(19) United States
(12) Patent Application Publication
(10) Pub. No.: US 2026/0055635 A1
(43) Pub. Date: Feb. 26, 2026

(54) Convertible Door Handle

(71) Applicant: NBR Brands, Inc., Brooklyn, NY (US)

(72) Inventor: Tzvi Rochlitz, Brooklyn, NY (US)

(73) Assignee: NBR Brands, Inc., Brooklyn, NY (US)

(21) Appl. No.: 19/306,816

(22) Filed: Aug. 21, 2025

Related U.S. Application Data
(60) Provisional application No. 63/685,591, filed on Aug. 21, 2024.

(51) Int. Cl. E05B 9/08; E05B 1/00

(52) U.S. Cl. CPC E05B 9/08; E05B 1/003

(57) ABSTRACT

A door that can be converted for use with wood or metal doors is disclosed. Removeable threaded posts are used with door handles for securement to a metal door. The posts are removed from the door handle for securement to a wood door. The handles can be converted for use with a metal door or a wood door by using the handles with the posts or without the posts, respectively.

### RELATED APPLICATIONS

This application claims priority to U.S. Provisional Application No. 63/685,591 filed on Aug. 21, 2024, the entire disclosure of which is hereby expressly incorporated by reference.

### FIELD OF THE DISCLOSURE

The present disclosure relates to door handles that can be converted for use with wood or metal doors.

### SUMMARY

The present disclosure relates to a door handle that can be installed on metal and wood doors. Removeable threaded posts can be used with door handles for securement of the door handle to a metal door, or the handles can be used without the posts for securement of the door handle to a wood door. As such, handles can be converted for use with a metal door or a wood door by using the handles with the posts or without the posts, respectively.

### BRIEF DESCRIPTION OF THE DRAWINGS

The foregoing features of the invention will be apparent from the following Detailed Description of the Invention, taken in connection with the accompanying drawings, in which:

FIG. 1 is a perspective view of door handles with removable posts for use with wood doors or metal doors.

FIG. 2 is another view of the door handles shown in FIG. 1 from another perspective.

FIG. 3 is a perspective view of one part of a door handle positioned in a door.

FIG. 4 is a perspective view of one part of a door handle positioned in a door and another part aligned for attachment thereto.

### DETAILED DESCRIPTION

The present disclosure relates to a door handle that can be installed on metal and wood doors.

Door handles are attached to wood doors by compressing the door handles against the wood so that the door handles grip the wood.

Door handles are attached to metal doors in a different way, namely posts are used that extend from the handles on each side or part of the handle. The posts extend through notches in the metal doors to thereby secure the relative positions of the handle parts with respect to the door. The pins are fixed to the handle and are not designed to be removed. As such, door handles designed for metal doors cannot be used for wood doors and vice versa.

The present disclosure relates to removeable threaded posts that are can be used with door handles for securement to a metal door, or the handles can be used without the posts for securement to a wood door. As such, handles can be converted for use with a metal door or a wood door by using the handles with the posts or without the posts, respectively.

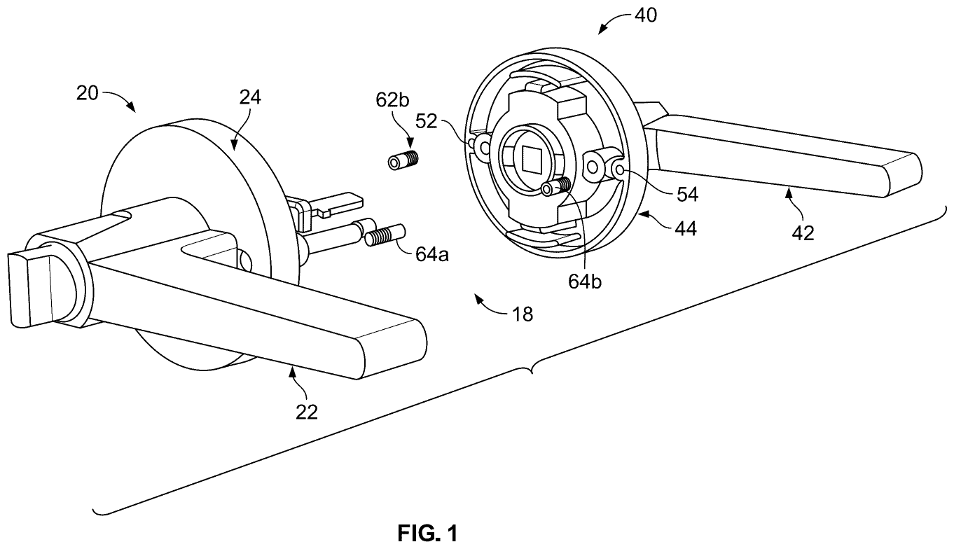

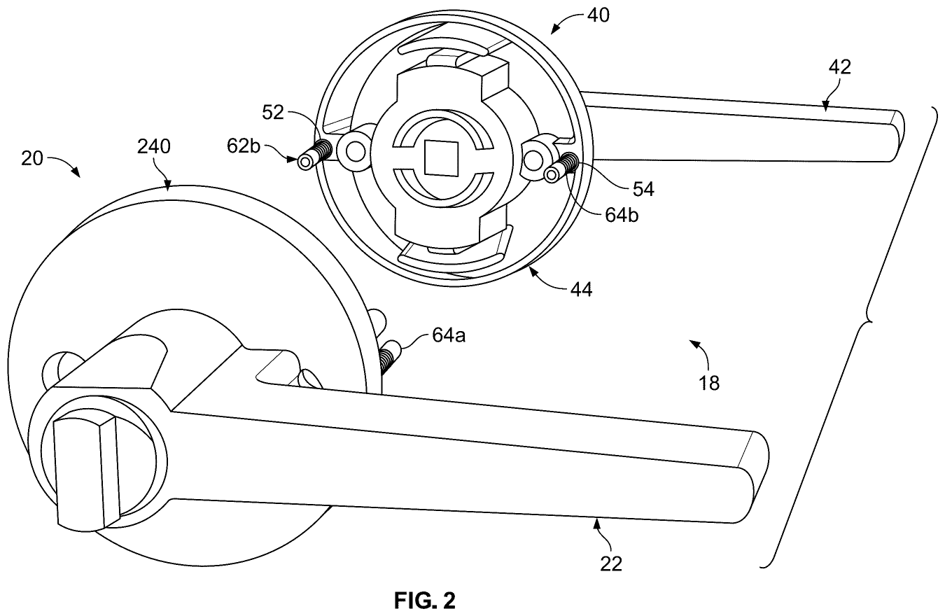

FIGS. 1 and 2 are perspective views of door handles with removable posts for use with wood doors or metal doors. A door handle 18 includes inner part 20 with handle 22 and fixture 24, and outer part 40 with handle 42 and fixture 44. Within fixtures 24 and 44 of inner and outer parts 20 and 40 are the open and closing mechanisms, as known in the art. Posts 62b and 64b, which may or may not be threaded, and if threaded, may be threaded at one or both ends may be attached by threading or otherwise, to receptacles 52 and 54 of outer part 40. Corresponding posts 64a and 64b (not shown), can be attached to corresponding receptacles in inner part 20 of handle 18.

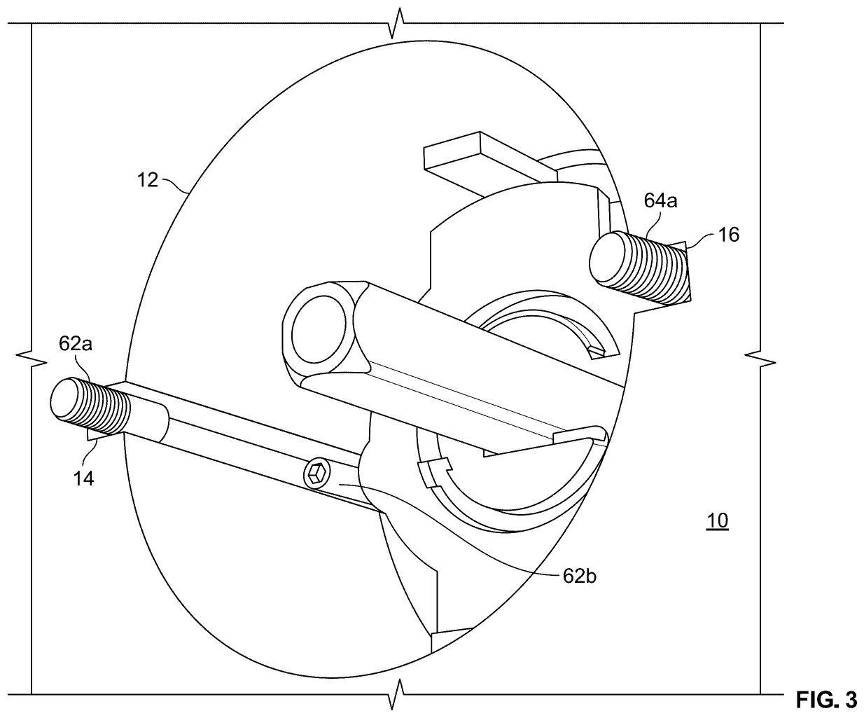

FIG. 3 is a perspective view of one part of a door handle positioned in a metal door 18 having a generally circular aperture 12 threrethrough. As can be seen, posts 62b and 64b can be attached within receptacles 52 and 54. Posts 62a, 62b, 64a and 64b are aligned to extend through notches 14 and 16 of aperture 12 in metal door 10. The notches 14 and 16 and the posts 62a, 62b, 64a and 64b coact to retain the inner part 20 and outer part 40 aligned and to prevent rotation of the inner part 20 and the outer part 40 with respect to metal door 10. The notches 14 and 16 surround the posts on three sides, and interfere with the posts to prevent rotation of the posts, and therefore the handle, with respect to the metal door 10.

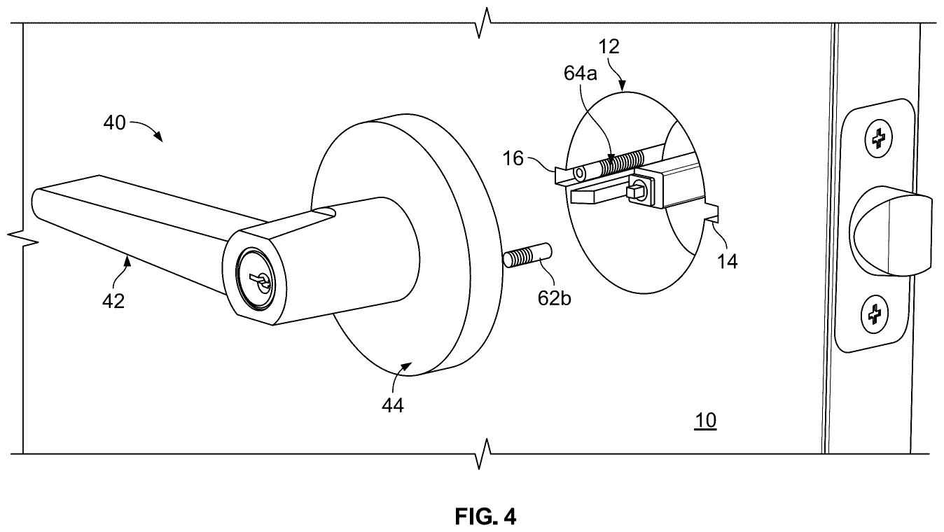

FIG. 4 is a perspective view of an outer part 40 of a door handle 18 positioned in a door 10 and the outer part 40 aligned for attachment to the inner part. Posts 62b (not shown) and 64b can be threadably engaged with the inner part 42, and extend into notches 14 and 16 in metal door 10. The notches 14 and 16 and the posts coact to retain the outer part 40 and inner part aligned and to prevent rotation of the outer part 40 and the inner part with respect to metal door 10. The notches 14 and 16 surround the posts on three sides, and interfere with movement of the posts to prevent rotation of the posts, and therefore the handle 18, relative to the metal door 10.

The posts are not used for wood doors, which do to not include notches. Door handles can be attached to wood doors, and retained in position, by exertion of a compressive force against the door. As such, handles are securely attached to a wood door to prevent rotation of the handles with respect to each other and the door.

Having thus described the disclosure in detail, it is to be understood that the foregoing description is not intended to limit the spirit or scope thereof. It will be understood that the embodiments of the present disclosure described herein are merely exemplary and that a person skilled in the art may make variations and modifications without departing from the spirit and scope of the disclosure. All such variations and modifications, including those discussed above, are intended to be included within the scope of the disclosure.

What is claimed is:

1. A convertible door handle comprising:
inner and outer handle parts;
first and second threaded receptacles on the inner handle part;
first and second threaded receptacles on the outer handle part;
first and second threaded inner posts for engagement with the inner handle part; and
first and second threaded outer posts for engagement with the outer handle part,
wherein, the first and second inner and outer posts are engaged with the first and second threaded receptacles on the inner and outer handle parts, and positioned to extend in first and second notches, for installation of the door handle on a metal door, and
wherein, the first and second inner and outer posts are removed from the inner and outer handle parts for installation of the door handle on a wood door.

2. The handle of claim 1 wherein the first and second inner posts and the first and second outer posts are threaded along a portion of the posts.

3. A convertible door handle system comprising:
inner and outer handle parts;
first and second inner threaded receptacles on the inner handle part;
first and second outer threaded receptacles on the outer handle part;
first and second threaded inner posts for engagement with the inner handle part; and
first and second threaded outer posts for engagement with the outer handle part, the first and second inner and outer posts threadably engageable with the first and second inner and outer threaded receptacles on the inner and outer handle parts, and positioned to extend in first and second notches in a metal door, for installation of the door handle on a metal door.

4. The handle system of claim 3 wherein the first and second inner posts and the first and second outer posts are threaded along a portion of the posts.

5. A method of converting a door handle for use with a wood door to a door handle for use with a metal door comprising:
providing door handles with first and second receptacles on inner and outer handle parts;
attaching the inner and outer handle parts to a wood door;
providing first and second inner and outer posts;
engaging the first and second inner and outer posts with the first and second receptacles on the inner and outer handle parts;
aligning the first and second inner and outer posts with notches on a handle aperture of a metal door; and
attaching the inner and outer handle parts to a metal door with the inner and outer posts positioned within notches on a handle aperture of a metal door.

6. The method of claim 5 wherein the first and second receptacles on the inner and outer handle parts and the first and second inner and outer posts are threaded, and engaging the first and second inner and outer posts with the first and second receptacles on the inner and outer handle parts comprises threading the posts into the receptacles.
